(19) United States
(12) Patent Application Publication
(10) Pub. No.: US 2003/0144953 A1
(43) Pub. Date: Jul. 31, 2003

(54) Industrial equipment cost estimation system and method

(76) Inventors: Joseph C. Razum, Greenville, SC (US); Sanjay Kumar Sharma, Greenville, SC (US); Mark D. McElhinny, Simpsonville, SC (US); Ronald Lee Williams, Anderson, SC (US)

Correspondence Address: Alexander M. Gerasimow, Allen-Bradley Company, LLC, 1201 South Second Street, Milwaukee, WI, 53204-2496, US

(21) Appl. No.: 10/062,801

(22) Filed: Jan. 31, 2002

(51) Int. Cl. G06F 17/60

(52) U.S. Cl. 705/40

(57) ABSTRACT

A total cost of ownership model is input by a series of graphical user interface pages. The model may include identification of specific tasks, including sub-activities and activities. Data sets are generated by progressively inputting costs, time, labor rates, and other key information for the various activities and sub-activities. Total cost of ownership calculations are made and the data may be rapidly and interactively displayed in graphical formats, tabulated formats, flow charts, and so forth. The tool permits the evaluation of both existing and alternative or solution scenarios for equipment ownership and servicing.

### BACKGROUND OF THE INVENTION

The present invention relates generally to the field of industrial and similar equipment and systems. More particularly, the invention relates to a technique for analyzing total costs of ownership and servicing of such equipment.

In the field of industrial equipment and systems a wide range of costs and expenditures may be encountered over the life of systems and subsystems. Depending upon the particular application, for example, systems installed in a factory, power plant, mine, material handling applications, storage warehouse, and so forth, may include original equipment or a combination of original equipment and components that may be retrofit or replaced over time. In either event, initial installation of systems and subsystems entails significant costs which are amortized over the useful life of the equipment. In addition to initial costs of the equipment and installation, industrial systems undergo regular and non-scheduled servicing. Regular servicing may include issues as simple as lubrication, verification of the state of the equipment, and so forth. Non-scheduled servicing may include items that are periodically needed as systems inevitably, but unexpectedly breakdown, both from natural problems with the equipment as well as from accidents or climatic conditions. In all of these cases, the costs associated with maintaining and servicing the equipment must be added to the initial costs to obtain a total cost of ownership.

A difficulty in engineering, specifying, and selling new and replacement systems, components and services related to such systems, entails accurately assessing the costs associated with ownership. While the initial costs and installation expenses can be generally accurately estimated, it is much more difficult to estimate the regular costs of ownership associated with servicing. In many industrial settings, for example, accurate records may simply not be kept that include all of the details required to evaluate the costs. Even where such records are kept, no satisfactory tool is presently available to integrate such costs with the initial costs of ownership in a meaningful manner that provides engineers, designers, purchasing agents, and other responsible personnel with information that should form the basis of an informed decision.

In comparing various alternatives for purchase and servicing of industrial equipment, managers may need to be informed not only of anticipated costs, but of various alternative management approaches. By way of example, known historical costs may be determined for specific systems or subsystems, while other, perhaps reduced, cost structures may be available through the use of alternative equipment, alternative servicing techniques, and so forth. In particular, it is believed that there are many instances in which higher initial costs for equipment may be more easily justified in view of reduced maintenance or service costs when a total cost of ownership model is used by the decision maker. Again, however, there is no satisfactory tool at present for interfacing with users to access such information, presenting the information in a meaningful manner, or comparing existing or historical solutions with alternative solutions in a simple and meaningful manner that emphasizes cost drivers and total cost of ownership.

There is a need, therefore, for an improved approach to evaluating total cost of ownership of equipment and systems in industrial settings. There is a particular need for a technique which can evaluate or estimate costs based upon historical information for both existing and new systems.

### SUMMARY OF THE INVENTION

The invention provides a novel technique for estimating total costs of ownership designed to respond to such needs. The technique may be employed in a wide range of settings, but is particularly adapted to evaluation of equipment ownership and maintenance costs in industrial settings. The type of equipment evaluated may vary widely, and may include such systems as production machinery, material handling machinery, automation machinery, and so forth. The technique offers a simple tool which can be used by sales personnel, management personnel, plant personnel, or engineers and designers for comparing and evaluating various options for equipment, both prior to installation and over the life of systems and subsystems. The tool is conveniently based upon a graphical user interface which may be provided in a resident program, a program stored on a media device such as a compact disc, or in a program which is interactively run.

In accordance with certain aspects of the technique, a user is prompted to input data relating to and describing a system or subsystem. Specific activities and sub-activities may be then identified, including tasks performed in sub-activities. The data sets descriptive of the tasks provide a basis for estimating costs. The costs may include both the actual costs of equipment and parts, the labor costs associated with preparation and installation of equipment, and costs of running the equipment. The data sets may also provide an indication of less direct costs, such as cost of down time, cost of obtaining and installing spare parts, costs associated with regular and unscheduled servicing, and so forth.

In addition to costs of current programs, the tool may facilitate calculation of similar cots of possible alternative equipment and programs. Specifically, in a total cost of ownership setting, the tool may be used to compare anticipated costs of existing or contemplated systems with similar costs of alternative systems, such as to determine the overall costs over time to compliment the calculation of the initial costs of the systems.

The tool provides an automatic and rapid mechanism for obtaining evaluation and feedback of the cost calculations. The feedback may include a variety of graphical tools, such as graphical displays of costs, particularly costs in a driver category. The feedback may also include a graphical representation of a flow chart for the particular activities, sub-activities, tasks, and so forth along with their associated costs. Finally, various detailed information may be provided to permit the decision maker to evaluate the bases for the results and to verify the foundation on which the costs are calculated.

### BRIEF DESCRIPTION OF THE DRAWINGS

The foregoing and other advantages and features of the invention will become apparent upon reading the following detailed description and upon reference to the drawings in which:

FIG. 1 is a diagrammatical representation of a cost evaluation system associated with an exemplary mechanical system in a form of a conveyor;

FIG. 2 is a flow chart illustrating exemplary steps in logic for prompting the input of data and evaluating the data for presentation of costs associated with ownership or servicing of equipment in a system of the type illustrated in FIG. 1;

FIG. 3 is a representation of an exemplary interface page for inputting information for use in the process of FIG. 2;

FIG. 4 is a representation of a further interface page for inputting cost driver category information;

FIG. 5 is an illustration of an exemplary interface page for inputting details of a data set relating to activities, sub-activities, and tasks associated with ownership or servicing of equipment through a process of the type illustrated in FIG. 2;

FIG. 6 illustrates a further interface page for inputting solution data for comparison purposes in conjunction with the data input via the page of FIG. 5;

FIG. 7 is an exemplary interface page illustrating an automatically generated flow chart for the exemplary system of FIG. 1;

FIG. 8 is an interface page illustrating automatic generation of an exemplary graphical comparison of costs for the system illustrated in FIG. 1; and

FIG. 9 is an exemplary detailed datasheet presented in an interface page and illustrating the bases for the calculations made in the exemplary analysis.

### DETAILED DESCRIPTION OF SPECIFIC EMBODIMENTS

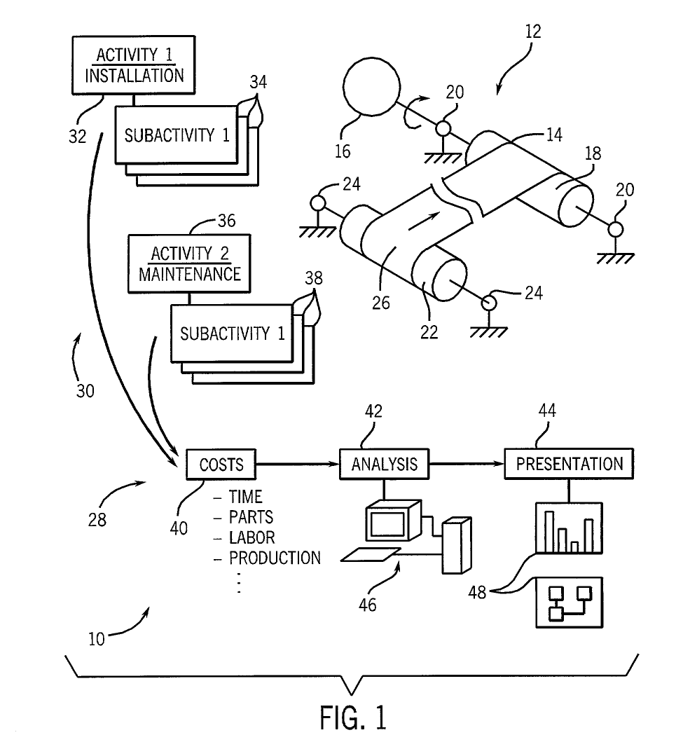

Turning now to the drawings, and referring first to FIG. 1, a system 10 is generally illustrated as including a basic mechanical system 12, and an associated analysis tool 28. As noted above, while any desired system may be used for the analysis purposes described herein, in the exemplary illustration of FIG. 1, a simple mechanical system 12 is referred to. System 12 includes, in this example, a conveyor 14 which is driven by a motor 16. Motor 16 drives a pulley 18 in rotation, and the pulley is supported on a shaft and bearings 20. A further pulley 22 serves to support the conveyor and is, in turn, supported by similar bearings 24 on a shaft. A belt 26 is disposed on pulleys 18 and 22 and may serve to transport material during use. Again, it should be noted that the conveyor system used as a basis for the present exemplary embodiment is simply a convenient example of a basic system. Other systems may include both mechanical, electrical, electromagnetic, computerized, or other systems. Similarly, the systems may be land or sea based, and may include components at one or a wide range of locations interacting directly or indirectly with one another.

Returning to FIG. 1, the analysis tool 28 is based upon certain characteristics of the mechanical system 12 which may be identified and summarized as indicated at reference numeral 30 in FIG. 1. The characteristics might be grouped in accordance with activities such as installation, as indicated at box 32. Such activities may be further sub-divided in sub-activities as noted at reference numeral 34. In the case of installation of a system 12, for example, sub-activities may include purchase and shipment of equipment, preparation of a site, installation of electrical and mechanical support components at the site, installation of the actual equipment, start-up of the equipment, and so forth. Other activities may be defined in the characteristics as indicated at reference numeral 36. In the example, the second activity may include maintenance, and may be further sub-divided into sub-activities 38. In the case of maintenance activities, such sub-activities may include items such as lubrication, physical inspection, replacement of parts on regular and non-scheduled bases, down time for regular and non-scheduled maintenance and servicing, costs of obtaining and shipping parts, costs of maintaining inventories and managing such inventories, and so forth.

The activities and sub-activities, as noted above, entail costs. These costs may be more or less known, and more or less apparent to management personnel based upon the manner in which they are handled. For example, purchase costs may obviously be traced to specific purchase orders or requisitions. Costs associated with shipping and storing, as well as insurance and similar costs may similarly tracked. Other costs will be less obvious and much more difficult to track. For example, costs both of new installations and of maintenance of installations may include parts, salaries of service personnel, hidden costs in maintaining and educating personnel, costs of down time, and so forth. Such costs are evaluated in the present technique in a cost identification module 40. More will be said of module 40 in the description of a specific implementation. However, in general, module 40 will include software running on a general purpose or application specific computer or computers, for prompting a user to input information relating to the activities, sub-activities, tasks, costs, and so forth. The module 40 is linked to an analysis module 42 which, again, will typically include appropriate programming code in a general purpose or application specific computer. The analysis module 42 generates cost computations based upon the input data sets, and provides output for a presentation module 44. The presentation module, too, may be part of an application specific or general purpose computer program.

In general, the cost identification module, the analysis module and the presentation module 44 may be a part of a single computer program. The program may run on a single computer station, such as station 46 illustrated in FIG. 1. Similarly, the computer system may be a laptop or a similar portable station which can be transported to a user location for interfacing with decision makers. Output, generally designated by reference numeral 48 in FIG. 1, may include graphical presentations of cost data computed by the system, as well as flow charts, and similar useful feedback. An interesting feature of the present technique is the ability to automatically and rapidly generate presentations of cost evaluations both for existing and alternative systems. The presentations may take any useful form, but graphical presentations of the data are preferred for their ability to simply and rapidly focus decision makers and designers on cost drivers, and on the consequences of specific investment and maintenance decisions on the overall cost of ownership.

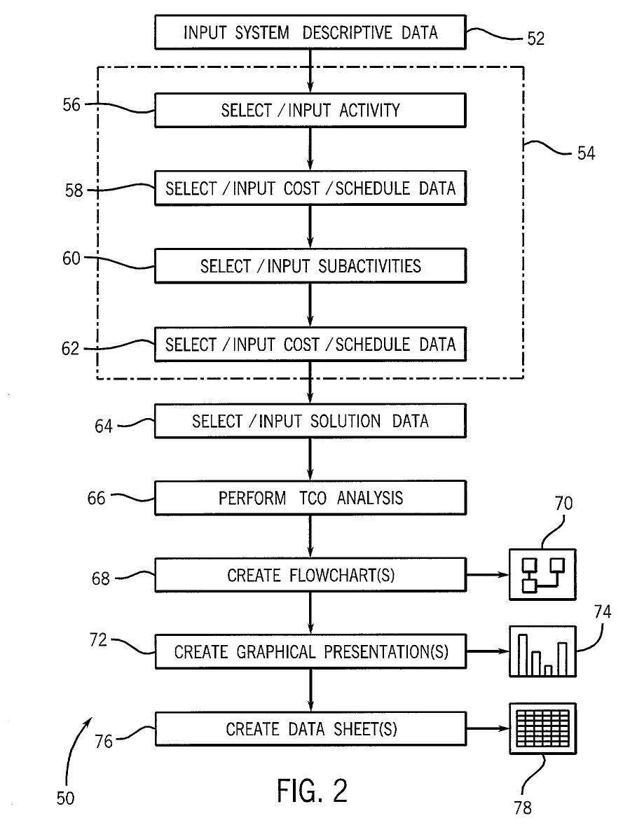

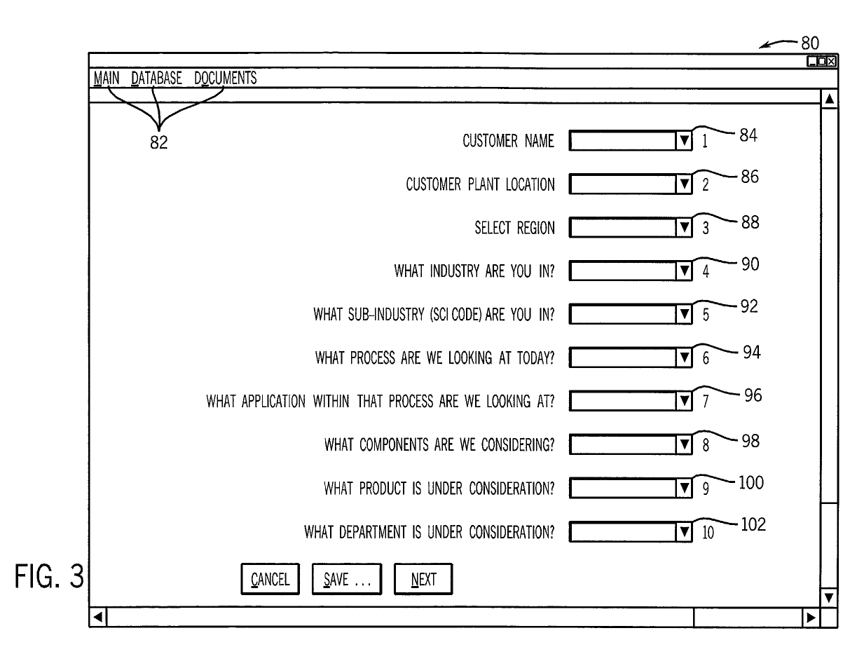

FIG. 2 represents exemplary steps in logic for inputting and analyzing cost data in a system of the type illustrated in FIG. 1. These steps are indicated generally by the reference numeral 50 in FIG. 2. Through the following explanation, reference will be made both to FIG. 2 and to the series of exemplary interface pages of FIGS. 3-9. The interface pages are examples of those that might be utilized to prompt, receive, and process data, as well as to select desired presentations of data analysis and comparison.

The steps summarized in FIG. 2 begin at step 52 wherein system descriptive data is input. As shown in FIG. 3, in an exemplary interface page 80, a series of navigation tools may be provided as indicated at reference numeral 82. Such tools permit the user to navigate between the various screens or interface pages described herein, as well as to store certain of the pages, configuration data, analysis results, and so forth. The system descriptive data is input via series of boxes or spaces labeled 84-102 in FIG. 3. Where appropriate the boxes may include drop-down menus. In a present configuration illustrated in the Figure, the descriptive data may include customer name, plant location, region for a system or subsystem, an industry code, a sub-industry code, and so forth. Blocks for this information are provided as indicated at reference numerals 84-92. An additional block is provided at numeral 94 for identifying a particular process under evaluation. A particular application may be specified at block 96. A list of one or more components may be identified at block 98, and specific products and departments identified at blocks 100 and 102.

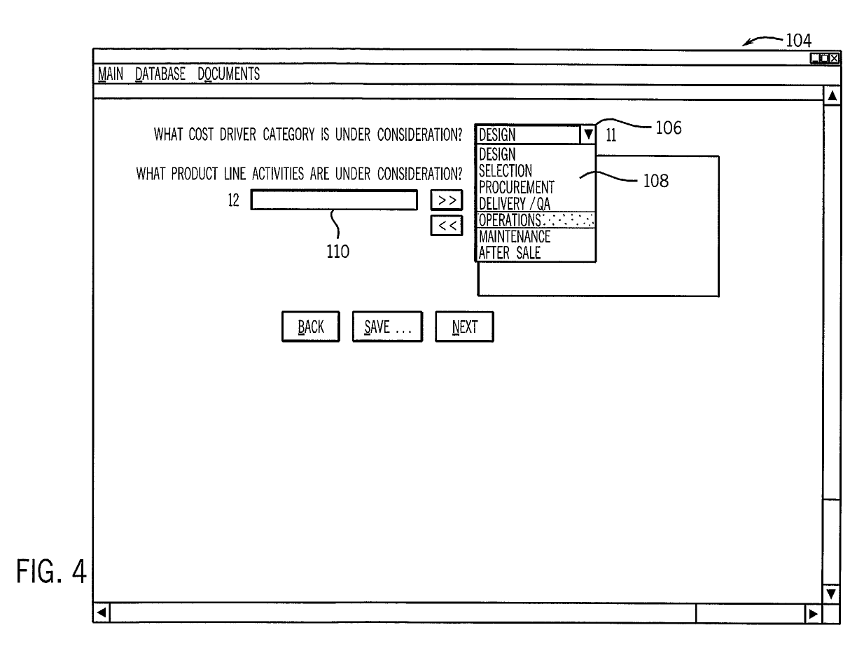

In accordance with the present technique, a particular cost driver category may be selected. FIG. 4 indicates an interface page for selection of such a driver category. As indicated at reference numeral 106 of the page 104, a drop-down menu 108 may be provided with a listing of such driver categories. The driver category represents the particular cost category that is under evaluation for comparison purposes. In the example the “operations” category has been selected, and is used as the basis for the decision making. Other cost categories may be provided such as maintenance, procurement, and so forth. The driver category may entail different or specialized cost evaluation algorithms, and may be crafted to evoke specific information related to the time of costs generally associated with that category. As indicated at block 110, additional identification information may be provided for specific product line activities under consideration.

Returning to FIG. 2, a series of steps identified by reference numeral 54 entail selecting or input identifications of specific activities, cost data, sub-activity data, schedule data, and so forth. In the present embodiment all such data may be considered as a data set. The data set includes specific lump costs, periodic costs, scheduled costs, activities and rates of costs per activity or per time period, and so forth. In all, the information input at the series of steps 54 will be sufficient to analyze and compile a total cost of ownership calculation for the specific application, activities, sub-activities, tasks and over the specific period in question.

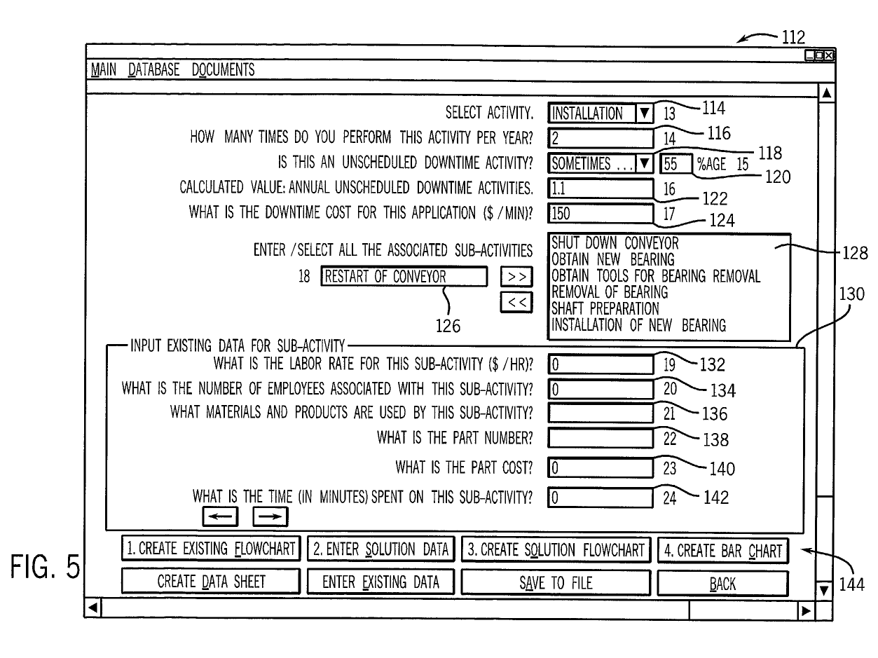

As indicated at step 56, the process begins with selection or input of an activity. The interface 112 of FIG. 5 illustrates exemplary blocks or menus for prompting the input of such information. As indicated at reference numeral 114, an activity may be selected or input by the user. In this case, the “installation” activity has been selected. As shown at block 58 in FIG. 2, cost or scheduled data is then selected or input for the specific activity. As shown at block 116, the user may be prompted on certain activities to input a rate performing the activities, such as number of occurrences per year. Where certain activities entail down time or similar computations, the classification of such down time may be input at block 118 and a percentage may be input at block 120 for the down time calculation. At block 122 the calculated value of unscheduled down time activities is input, and a cost of such down time is input or estimated at block 124.

In addition to these specific activities, sub-activities may be selected or input by the user. In general, the use of sub-activities permits greater and more detailed analysis for evaluation of the specific tasks entailed in the activity. In the example illustrated, sub-activities include shut down of a conveyor, obtaining a new bearing, obtaining tools for the bearing removal, removal of the bearing, shaft preparation, and installation of a new bearing. The sub-activities are grouped as indicated at reference numeral 28, having been input at a block 126.

Once the sub-activities have been selected or input as indicated at step 60 in FIG. 2, data descriptive of costs of such activities is input or selected as indicated at step 62 of FIG. 2. Returning to FIG. 5, blocks 132-134 prompt a user to identify labor rates, employees associated with sub-activities, materials and products, part numbers, costs, and time spent on specific sub-activities. As will be appreciated by those skilled in the art, such data is then used to compute the value of the individual sub-activities for the total cost of ownership calculation. It should be noted that in addition to the foregoing information, the interface page 112 permits navigation to specific presentations based upon the calculations made. Accordingly, in the illustrated embodiment flow charts, solution data, bar charts, and so forth may be selected from a menu 144. By appropriately navigating through the various activities, and sub-activities identified by the user, highly interactive and complete “snap-shots” may be input by the user of specific processes. Again, the data may be generated based upon anticipated or actual activity and sub-activity data. Globally, such activities may be thought of as tasks which are performed and costs entailed in ownership and servicing of equipment. To the extent that the information is accurate and complete, the total cost of ownership calculations may be made, such as by multiplying labor rates times time value, times number of occurrences, and summing the resulting computations.

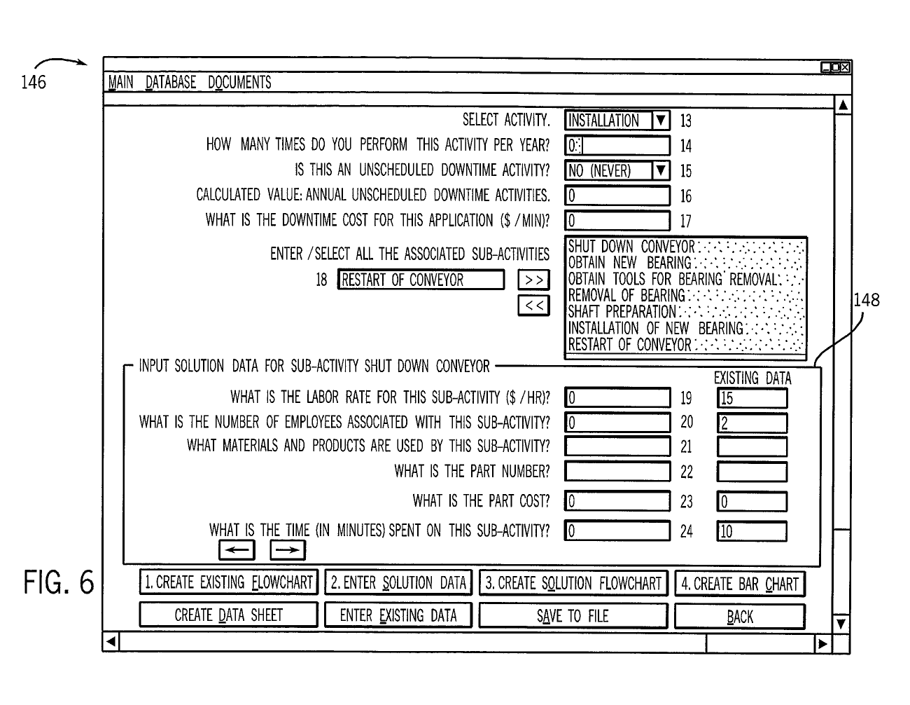

The present system also permits comparison of a number of different solutions for ownership scenarios. In particular, the tool is well suited to comparing existing service programs with upgraded or alternative service programs as indicated in the interface page 146 of FIG. 6. As shown in FIG. 2, such pages may be considered as solution data set pages as indicated at step 64 of the process. In the illustrated example, the solution data set interface page may be substantially identical to the page illustrated in FIG. 5 for the existing activity and sub-activity identification, but includes a column for section 148 for solution data. The solution data may differ from the existing data in that different or alternative products, parts, processes, and so forth are utilized. To facilitate comparison, the existing data already entered by the user for particular activities or sub-activities may be displayed as shown in FIG. 6.

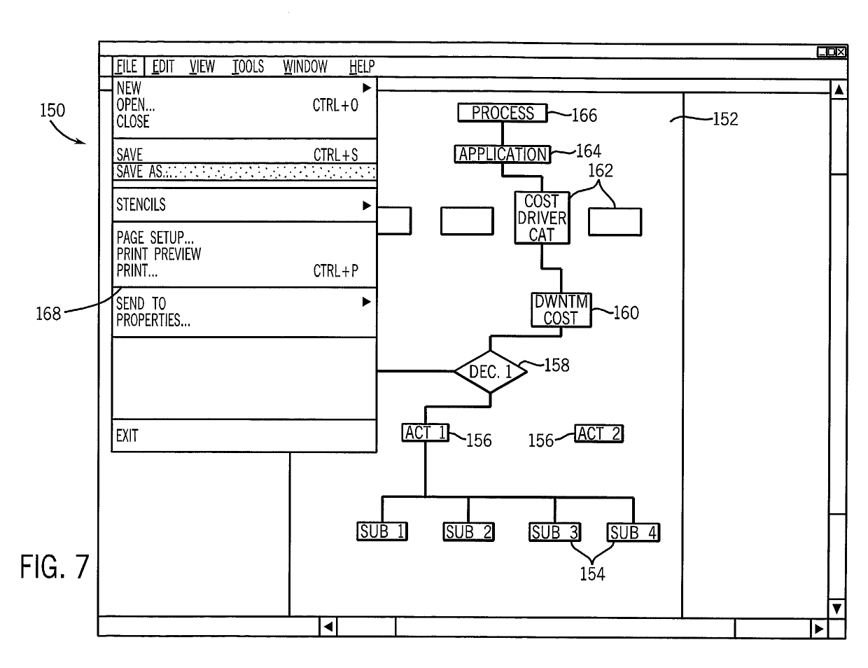

The present technique is adapted to automatically and interactively generate presentations for the processes as indicated in FIGS. 7-9. In a particularly useful aspect of the technique, a flow chart of the specific process, application, and activity and sub-activity categories is generated in real time as indicated in FIG. 7. Such flow charts may be accessed by simply selecting a create flow chart virtual button of the type shown in FIGS. 5 and 6. A resulting interface page 150 is displayed that includes a flow chart 152. In a present embodiment, the flow chart is designed to display a hierarchy of tasks from sub-activities 154 to activities 156. Decision blocks 158 may be included, such as for display of down time costs versus no down time costs, with down time costs in the present embodiment being displayed or called out at a block 160. All of the information is again linked to a cost driver category as indicated at reference numeral 162. Finally, the specific application and process are called out as shown at reference numerals 164 and 166. A user may print, save, or otherwise access the flow chart via one or more drop-down menus as indicated at reference numeral 168. The flow charts again help to identify the various activities and sub-activities input by the user, and to verify that the input model is accurate and correct. Moreover, where both existing and solution or alternative data sets are provided, the flow chart may indicate one or both of these and their associated costs.

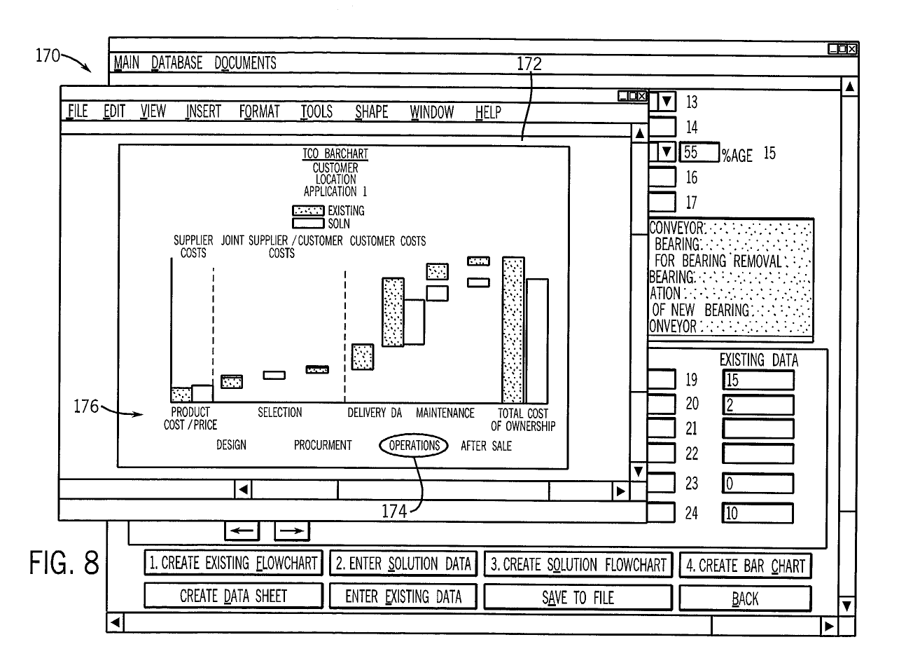

As shown in FIG. 8, the present embodiment also permits graphical representations of costs to be generated and displayed. In particular, a cost bar chart is accessed by selection of one of the virtual buttons at the bottom of the interface page. The interface page then, referred to by reference numeral 170 in FIG. 8, provides a display 172 of the various costs involved in the application input by the user. To render the presentation even more meaningful, and to emphasize specific cost drivers, these may be displayed in different manners as indicated for the operations cost driver 174 in FIG. 8. Comparisons of existing and alternative or solution costs may be particularly called out or aligned so as to emphasize cost savings. Other cost driver categories may also be displayed as indicated at reference numeral 176 as may a total cost of ownership comparison. Again, such presentations are generated automatically by the software based upon the collection of data input by the user. It should also be noted that changes in the input information are automatically reflected in the presentations made in both the flow chart of FIG. 7 and in the comparison and total bar chart of FIG. 8.

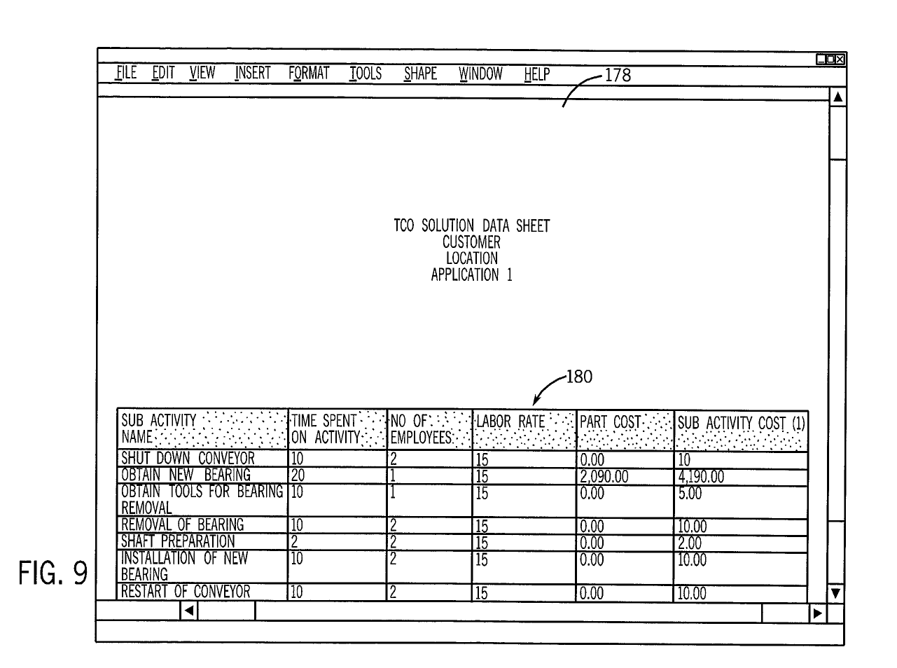

Following a creation of graphical representations as indicated at step 72 in FIG. 2, data sheets may be created as indicated at step 76. An exemplary data sheet is shown in FIG. 9. The data sheet displayed in a page 178 includes a chart 180 which simply reflects the various information input by the user. Because the graphical representation may require or call for certain explanatory notes, such raw data simulations may be desirable. In all of the cases of output creation summarized in FIG. 2, the actual output whether in the form of a flow chart 70, a graphical representation 74 or a tabulated presentation 78 may be stored, printed, transmitted to remote locations, and so forth as desired by the user.

It has been found that the present tool permits rapid and interactive identification of the various cost categories in equipment ownership, maintenance, servicing, and repair. In particular, the tool is well-suited for cost justification in new and retrofitted purchases and servicing decisions. Because the total cost of ownership is the basis for the calculations, and because certain cost drivers may be the focus of the evaluation, rapid and interactive presentation of both the process flow and costs summary are particularly useful to decision making.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method for analyzing costs associated with an industrial control and monitoring system, the method comprising:
defining tasks performed in servicing the system;
computing costs of servicing the system based upon the tasks, the costs including costs in a driver category;
analyzing the computed costs; and
automatically generating a graphical display of total costs of operations based upon the defined tasks and computed costs.

2. The method of claim 1, wherein the tasks are defined in specific classifications of activities.

3. The method of claim 1, wherein the tasks are user defined via a graphical user interface.

4. The method of claim 1, wherein the costs are computed over a predetermined time period.

5. The method of claim 1, wherein the graphical display includes a chart of costs for servicing displayed in categories, including the driver category.

6. The method of claim 1, further comprising automatically generating a process flow chart of the tasks and costs associated with the tasks.

7. The method of claim 1, wherein the costs are computed for an existing servicing data set and for a solution servicing data set.

8. The method of claim 7, wherein the graphical display illustrates a comparison between costs computed for the existing servicing data set and the solution servicing data set.

9. A method for analyzing total costs of ownership of industrial equipment, the system comprising:
prompting user input of system descriptive data;
prompting user input of tasks performed ownership and servicing of industrial equipment;
prompting user input of a cost data set for the tasks;
computing total costs of ownership data based upon the tasks and the cost data set; and
generating and displaying a graphical representation of computed total costs of ownership.

10. The method of claim 9, wherein the step of prompting user input of a costs data set includes prompting input of an existing costs data set and of a solution costs data set.

11. The method of claim 10, wherein the step of computing total costs of ownership data includes computing data based on the existing costs data set and computing data based on the solution costs data set.

12. The method of claim 11, wherein the step of generating and displaying the graphical representation includes displaying a comparison of cost data computed based on the existing costs data and cost data computed based on the solution costs data.

13. The method of claim 9, further comprising displaying a flow chart of tasks input by the user.

14. A method for analyzing total costs of a user system, the method comprising:
defining activities and subactivities encountered during at least a portion of a useful life of the system;
identifying cost parameters for each of the activities and subactivities;
determining at least two different cost models based upon the activities and subactivities and upon the cost parameters; and
generating a user viewable page summarizing the cost models.

15. The method of claim 14, wherein the activities and subactivities are defined via a user viewable interface page.

16. The method of claim 14, wherein the cost parameters include costs of installation of the system.

17. The method of claim 14, wherein the cost parameters include costs of maintaining the system.

18. The method of claim 14, wherein the cost parameters include costs of labor.

19. The method of claim 14, wherein the at least two different cost models include a model based upon an existing system configuration and a model based upon an alternative system configuration.

20. The method of claim 14, wherein the user viewable page includes a flow chart summarizing the activities and subactivities.

21. The method of claim 14, wherein the user viewable page includes a graphical representation of costs.

22. A system for analyzing costs, the system comprising:
a plurality of user interface pages adapted to prompt input of task data and cost data based upon the tasks;
an analysis module configured to receive the task data and the cost data and to compute costs of performing the tasks in accordance with at least two different cost models; and
an output module configured to generate a graphical representation of the tasks and costs computed by the analysis module.

23. The system of claim 22, wherein the interface pages are displayed on a user workstation.

24. The system of claim 22, wherein user interface pages are configured to permit user identification of the tasks.

25. The system of claim 22, wherein the analysis module is adapted to analyze costs of installation of equipment.

26. The system of claim 22, wherein the analysis module is adapted to analyze costs of maintaining equipment.

27. The system of claim 22, wherein the analysis module is adapted to analyze costs of labor.

28. The system of claim 22, wherein the at least two different cost models include a model based upon an existing machine system configuration and a model based upon an alternative machine system configuration.

29. The system of claim 22, wherein the graphical representation includes a flow chart summarizing the tasks.

30. The system of claim 22, wherein the graphical representation includes a bar chart of costs.
